(19) United States
(12) Patent Application Publication
(10) Pub. No.: US 2014/0344324 A1
(43) Pub. Date: Nov. 20, 2014

(54) PROXIMITY PREFERENCE DISPLAY OPERATING SYSTEM AND PROXIMITY PREFERENCE DISPLAY OPERATING METHOD

(71) Applicant: Ki Young CHUN, Seoul (KR)

(72) Inventor: Ki Young CHUN, Seoul (KR)

(21) Appl. No.: 14/447,899

(22) Filed: Jul. 31, 2014

Related U.S. Application Data
(63) Continuation-in-part of application No. 13/981,292, filed on Jul. 23, 2013.

(30) Foreign Application Priority Data
Jan. 25, 2011 (KR) 10-2011-0007393

(51) Int. Cl. H04L 29/08

(52) U.S. Cl. CPC H04L 67/306
USPC 709/202

(57) ABSTRACT

The present invention relates to an operating system for displaying proximity preferences, and more particularly, to an operating system for displaying proximity preferences capable of establishing an information communication environment so that users having similar preferences or interests can form a group to be displayed within a short distance, thereby easily checking the status of users or institutions having similar interests and preferences, and allowing the users or institutions to do their positive activities so as to obtain new information quickly and easily as well.

### CROSS REFERENCE TO RELATED APPLICATIONS AND CLAIM OF PRIORITY

The present application is a continuation-in-part application to U.S. patent application Ser. No. 13/981,292, filed Jul. 23, 2013, which is a National Phase application under 35 U.S.C. §371 of International Application No. PCT/KR2011/000572, filed Jan. 27, 2011, which claims priority to Korean Patent Application No. 10-2011-0007393 filed Jan. 25, 2011, entire contents of which are incorporated herein by reference.

### BACKGROUND

1. Technical Field

The present invention relates, in general, to an operating system for displaying proximity preferences, and, more particularly, to an operating system for displaying proximity preferences capable of establishing an information communication environment so that users having similar preferences or interests can form a group to be displayed on a terminal screen within a short distance, thereby easily checking the status of users or institutions having similar interests and preferences, and allowing the users or institutions to do their positive activities so as to obtain new information quickly and easily as well.

2. Background Art

In recent years, information communications may be used to exchange information between users at not only a short distance but also a remote distance in various manners to provide environments for active information exchange.

In particular, desktop computers and notebook computers widely used in the related art have been used to get access to general portal sites, social meeting sites or employ personally specialized communication means such as twitters, facebooks, chats, mails and the like. Also, portable terminals such as mobile phones, PDAs, navigation systems and the like, especially communication means, such as smart phones, which are easily portable and conveniently used in recent years, have been used to provide circumstances which enables the user to make active actions such as internet searches, club activities, social meeting activities and the like.

A large amount of information may be freely exchanged in the various information means and diversified environments. In particular, users take part in certain fields which are specialized for their activities, which makes it possible for the users to effectively enjoy their personal time.

Accordingly, most users optimally find new fields, desired hobby activities or new interests and take a part in activities so as to further enhance activity efficiency and improve a degree of achievement satisfaction. However, most users tend to depend on general searches, or look for fields of activity through recommendation of acquaintances. As a result, there is a limit in conducting information exchange under very restricted circumstances.

In particular, in the clubs, social meetings or interests in which the users take part, when the users do not try to search for and accept new situations or new information which are changing every hour, it is difficult to find the corresponding information. As a result, the users may unfortunately gradually lose interest in searching for the new situations or information, and thus may encounter difficulties in agreement formation with other peoples due to ignorant and outdated contemporary information.

### SUMMARY

Therefore, to solve the problems, the present invention is directed to an operating system for displaying proximity preferences capable of establishing an information communication environment so that users having similar preferences or interests can form a group to be displayed on a terminal screen within short distance, thereby easily checking the status of users or institutions having similar interests and preferences, and allowing the users or institutions to do positive activities so as to obtain new information quickly and easily as well.

Also, the present invention is directed to an operating system for displaying proximity preferences capable of allowing users to easily view similar preferences or matters of interest, or notices associated with the users forming a group by means of visualized expression means such as a speech balloon, a text box and the like, thereby facilitating new information exchange between the users.

In addition, the present invention is directed to an operating system for displaying proximity preferences capable of displaying a group of preferences and interests or a group of user at a near position on a terminal screen according to the users' own desired liking so as to easily check the status of users, which makes it possible to allow more active information exchange.

Aspects of the present invention are not limited to the above-described aspects, and other aspects, not described here, will be more clearly understood by those skilled in the art from the following detailed description.

In order to accomplish the above aspects, the present invention provides an operating system for displaying proximity preferences including a proximity preference processing system 20 configured to receive data from a client 11 and transmit set data of a proximity display distance according to preference classification for users toward the client 11 by means of preference classification for data of a client user. Here, the proximity preference processing system 20 includes a preference analysis and classification unit 21 configured to receive preference data of users of the client 11, analyze the preference data and classify the preference data of the users according to individual preference data, a proximity display set unit 22 configured to set a proximity distance in which the users are displayed adjacent to each other according to the data classified by the preference analysis and classification unit 21, a member information storage unit 23 configured to store data of user members, and a preference field storage unit 24 configured to store the set data of the proximity display distance set according to the data of the preference classification for the users and attributes of preference data.

In this case, a GUI screen 12 of the client 11 configured to receive the set data of proximity display distance according to the preference classification for the users includes a proximity preference display unit 30 configured to display the users according to similar preference attributes, and a function display unit 40 configured to allow the client user to input data and display a menu. In this case, the proximity preference display unit 30 is configured to display the users based on the groups including the similar preference attributes, and express the respective users as at least one selected from the group consisting of an avatar, a speech balloon, a text box and a character, and the users are displayed on the proximity preference display unit 30 so that a logged-in user is tinted with a color tone, or is displayed as at least one selected from the group consisting of the avatar, the speech balloon, the text box and the character, all of which are colored, and a user in a logged-out state is displayed in the form of a frame as at least one selected from the group consisting of the avatar, the speech balloon, the text box and the character, or is indicated in an achromatic color.

Also, when a displayed zone of the users is selected in the form of one of the avatar, the speech balloon, the text box and the character in the proximity preference display unit 30 displayed on the GUI screen 12 of the terminal of the client 11, a personal space screen 31 of the corresponding user is displayed. In this case, the proximity preference processing system 20 may further include a personal space display unit 25 configured to search for data of display contents regarding the corresponding user displayed on the personal space screen 31 of the corresponding user and transmit the data toward the client 11 when the data are received according to selection of the displayed zone of the user displayed on the GUI screen 12 of the terminal of the client 11.

In addition, the present invention provides an operating system for displaying proximity preferences includes a proximity preference processing system 20 configured to receive data from the client 11 and transmit set data of the proximity display distance according to preference classification for the users toward the client 11 by means of preference classification for data of the client user. Here, the terminal of the client 11 is configured to receive the set data of the proximity display distance according to the preference classification for the users, and the GUI screen 12 of the client 11 includes a proximity preference display unit 30 configured to display users based on similar preference attributes, and a function display unit 40 configured to allow a client user to input the data and display a menu. Also, the proximity preference display unit 30 is configured to display the users based on the groups including the similar preference attributes and express the respective users in the form of a group including at least one selected from the group consisting of an avatar, a speech balloon, a text box and a character according to the similar preference attributes.

Additionally, the present invention provides an operating method of displaying proximity preferences, which includes a preference analysis and classification step (S01) of receiving preference data of users from a client 11, analyzing the preference data and classifying the preference data of the users based on individual preference attributes; a proximity displaying and setting step (S02) of setting a proximity distance in which the users are displayed adjacent to each other according to the preference data classified in the preference analysis and classification step (S01); and a user-in-preference-group displaying step (S03) of transmitting set data of proximity distance according to the preference attributes of the users and user display data for displaying users as a group including at least one selected from the group consisting of an avatar, a speech balloon, a text box and a character corresponding to each of the users from the proximity preference processing system 20 to the client 11 and displaying the set data of proximity distance and the user display data on the proximity preference display unit 30 of the GUI screen 12 of the client 11. Here, the users may be displayed for a preference group including a large number of users.

In this case, the operating method of displaying proximity preferences may further include an individual selection/information transmission step (S04) of transmitting individual selection data, in which a displayed zone of user individuals is selected in the form of one of the avatar, the speech balloon, the text box and the character in the proximity preference display unit 30 displayed on the GUI screen 12 of the terminal of the client 11, from the client 11 to the proximity preference processing system 20; and an individual information displaying step (S05) of receiving the individual selection data, searching for information on corresponding individual users, transmitting searched data on individual information data from the proximity preference processing system 20 to the client 11 and displaying the individual information data on the personal space display unit 25 of the GUI screen 12 of the client 11.

Furthermore, the preference data of the users may include data including at least one selected from the group consisting of an occupation preference, a region preference, a hobby preference, a sports preference, a merit preference, an interest preference, a schoolmate preference, a hometown preference, and a social club preference.

The present invention configured thus has the following excellent advantages.

The operating system for displaying proximity preferences according to the present invention can be useful in establishing an information communication environment so that users having similar preferences or interests can form a group to be displayed and checked on a terminal screen within a short distance, thereby easily checking the status of users or institutions having similar interests and preferences, and allowing the users or institutions to do positive activities so as to obtain new information quickly and easily as well.

Also, the operating system for displaying proximity preferences according to the present invention can be useful in allowing users to easily view similar preferences or matters of interest, or notices associated with the users forming a group by means of one of a speech balloon, a text box and the like, thereby facilitating new information exchange between the users.

### BRIEF DESCRIPTION OF DRAWINGS

The above and other aspects, features and advantages of the present invention will become more apparent to those of ordinary skill in the art by describing in detail exemplary embodiments thereof with reference to the accompanying drawings, in which:

FIG. 1 is a schematic organization chart showing an operating system for displaying proximity preferences according to one exemplary embodiment of the present invention;

FIG. 2 is a flowchart illustrating the operating system for displaying proximity preferences according to one exemplary embodiment of the present invention;

FIG. 3 shows an entire main screen which is displayed on a client GUI screen in the operating system for displaying proximity preferences according to one exemplary embodiment of the present invention;

FIG. 4 shows a particular screen of the main screen which is displayed on a client GUI screen in the operating system for displaying proximity preferences according to one exemplary embodiment of the present invention;

FIG. 5 shows a screen presenting market contents displayed on a client GUI screen in the operating system for displaying proximity preferences according to one exemplary embodiment of the present invention;

FIG. 6 shows a screen presenting personal spaces displayed on a client GUI screen in the operating system for displaying proximity preferences according to one exemplary embodiment of the present invention;

FIG. 7 is an entire flowchart illustrating an operating method of displaying proximity preferences using the operating system for displaying proximity preferences according to one exemplary embodiment of the present invention;

FIG. 8 is a flowchart designed according to input and classification of preference data of member users in the operating method of displaying proximity preferences using the operating system for displaying proximity preferences according to one exemplary embodiment of the present invention;

FIG. 9 is a flowchart designed according to analysis of display distance between the member users according to the preference of the member users in the operating method of displaying proximity preferences using the operating system for displaying proximity preferences according to one exemplary embodiment of the present invention;

FIG. 10 is an exemplary flowchart illustrating a process of analyzing and classifying attributes for user input data in the operating system for displaying proximity preferences according to one exemplary embodiment of the present invention;

FIG. 11 is an exemplary flowchart illustrating exemplary data input for the process of analyzing and classifying attributes for user input data in the operating system for displaying proximity preferences according to one exemplary embodiment of the present invention; and

FIG. 12 is an exemplary flowchart illustrating a process of producing the analyzed and classified data as proximity display data in the operating system for displaying proximity preferences according to one exemplary embodiment of the present invention.

### DETAILED DESCRIPTION

As the terms used in the present invention, typical terms currently and widely used have been selected wherever possible, but, in specific cases, terms arbitrarily selected by the applicant are also used, and in this case, the meanings of the terms should be determined in consideration of meanings described or used in the detailed description of the invention, rather than merely considering the simple names of the terms.

Hereinafter, technical configuration of the present invention will be described in detail with reference to exemplary embodiments shown in the attached drawings.

However, the present invention may be embodied in other forms without being limited to the embodiments described here. The same reference numerals are used throughout the present specification to designate the same components.

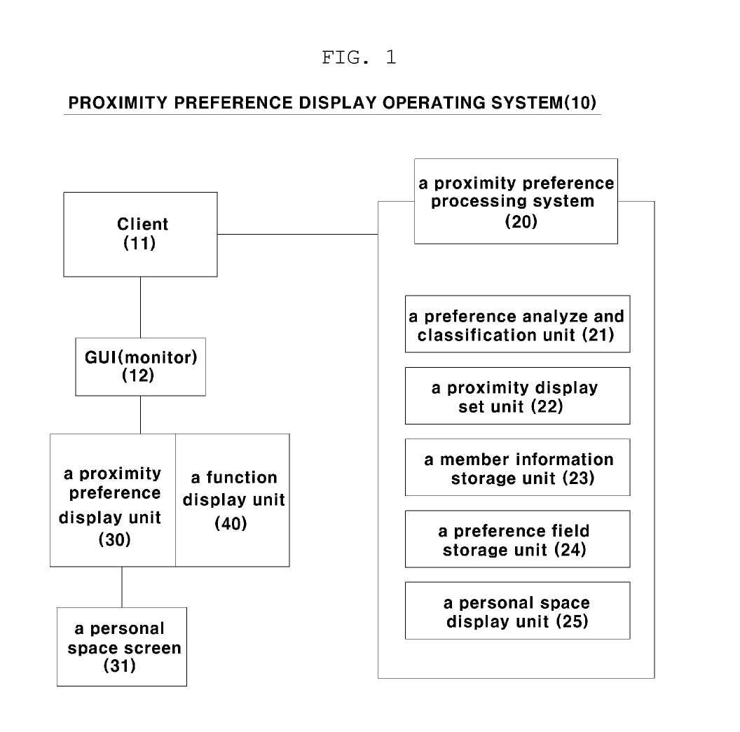

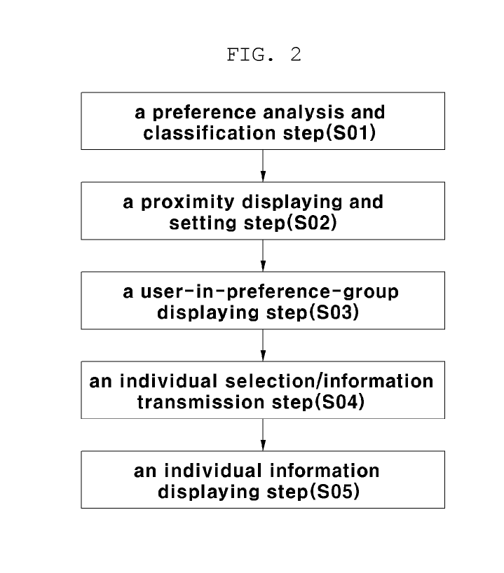

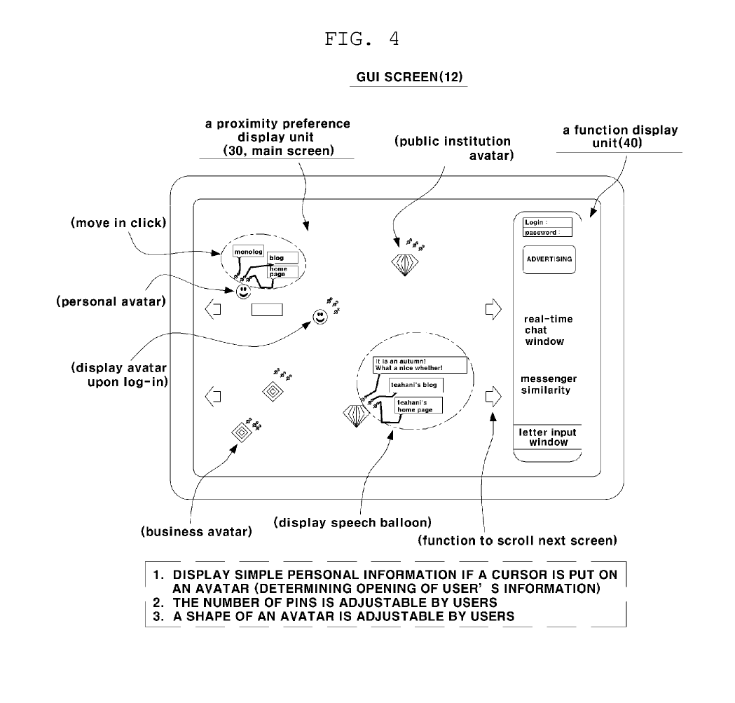

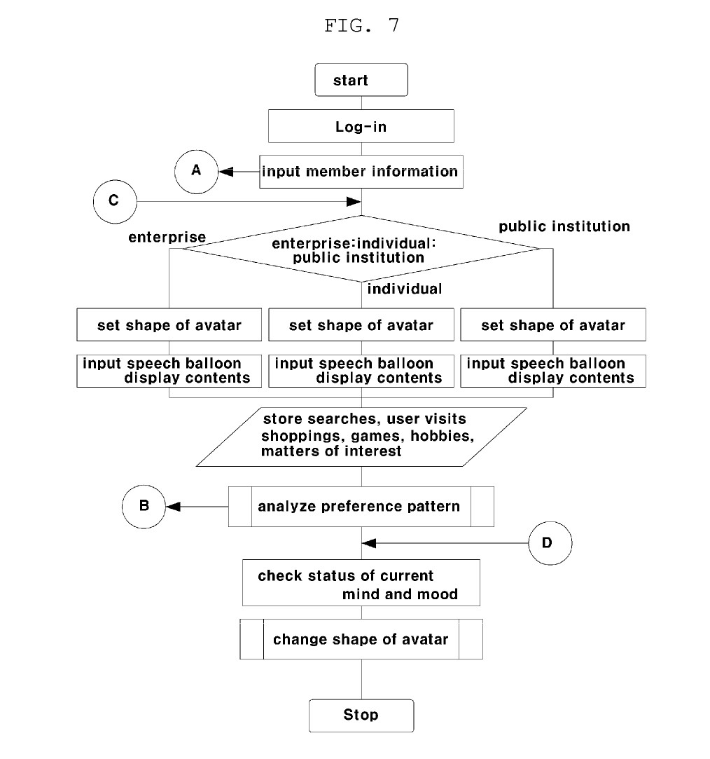

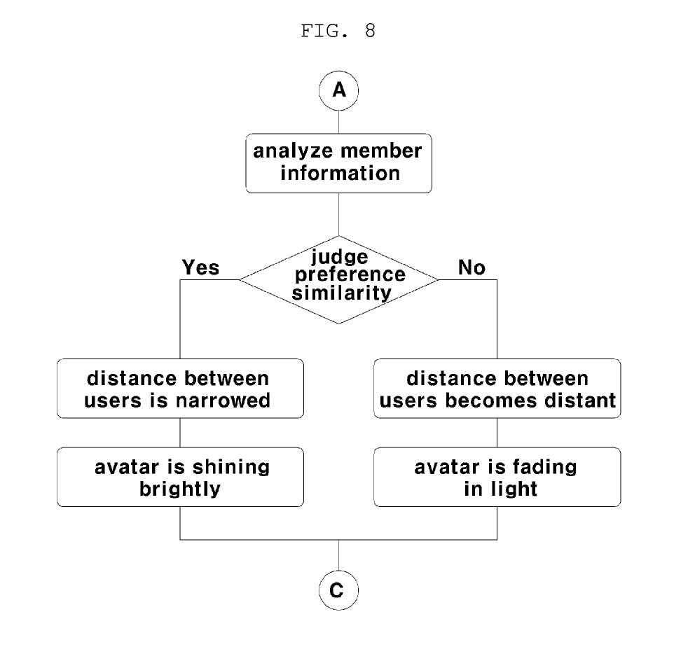

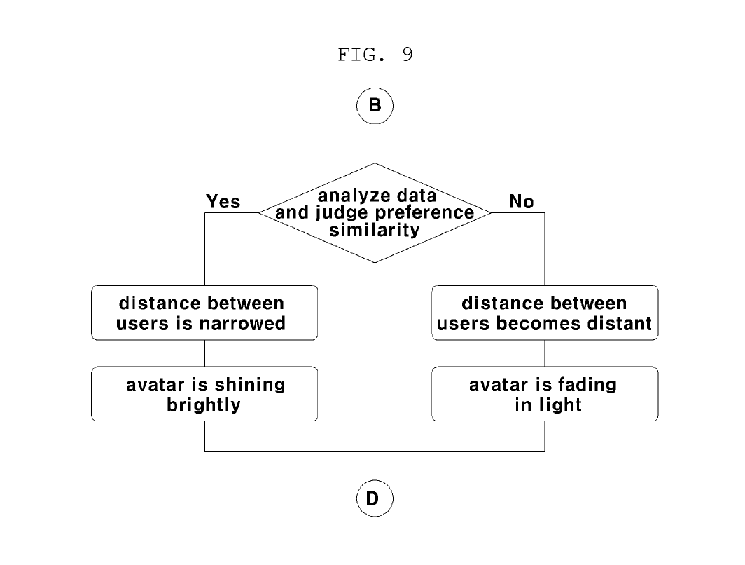

That is, an operating system 10 for displaying proximity preferences (that is, proximity preference display operating system) and an operating method of displaying proximity preferences (that is, proximity preference display operating method) according to the present invention are provided, as shown in FIGS. 1 through 12. In this case, the operating system 10 for displaying proximity preferences according to the present invention includes a proximity preference processing system 20 configured to receive data from a client 11 and transmit proximity set data. In this case, the preference-related analysis and display data of the user transmitted from the proximity preference processing system 20 are transmitted to a corresponding client terminal to be displayed on a GUI screen of a client.

Referring to a configuration of the proximity preference processing system 20, the proximity preference processing system 20 includes a preference analysis and classification unit 21 configured to receive preference data from a user of a client 11, analyze the preference data and classify the preference data of the user based on the individual preference attributes, and a proximity display set unit 22 configured to carry out a mathematical operation on the set data of proximity distance to display the user adjacent to each other according to the preference data classified at the preference analysis and classification unit 21.

That is, the present invention may be provided to receive the preference data of the users together with information of user members from a user using a terminal of the individual client 11. Then, the present invention may be provided to carry out a member joining procedure or a log-in procedure of a joined member according to the input information of the user, and analyze and classify the preference data of the users and produce proper display data according to the classified contents as well.

Subsequently, a member information storage unit 23 configured to store data of user members so as to store information input/output together with basic information on each member user is provided. Also, a preference field storage unit 24 configured to store set data of a proximity display distance set according to the data regarding the preference classification for users and a degree of preference may be provided.

In the operating system 10 for displaying proximity preferences and the operating method of displaying proximity preferences according to the present invention, referring to the above-described classification of the preference data of the users, various preferences which a user may select, for example, an occupation preference, a region preference, a hobby preference, a sports preference, a merit preference, an interest preference, a schoolmate preference, a hometown preference, a social club preference and the like may be determined. The kind of classification of such user preference data may be carried out in addition to the groups to be applied, social viewpoints, matters of interest, main cultural preferences, etc.

Also, the preference classifications may be made into more divided preference classifications. In the case of the occupation classification, for example, general matters of interest may include ‘occupation interest classification,’ more particularly, may be further divided into ‘teacher classification,’ ‘public official classification,’ ‘information communication classification,’ ‘IT occupation classification,’ ‘sale classification,’ ‘legal circle classification,’ ‘academy classification,’ ‘manufacturing classification,’ ‘trade classification,’ ‘communication sale classification’ and the like. The region classification may be carried out for countries. In one country, for example, the region classification may be may be divided into preference classifications which are then further divided for individual regions. According to various aspects, the preference classifications may be set as described above. The preference classifications may be carried out to select the kinds of a number of preference classifications at the time when a user join activities, and allow an individual user to select and determine degrees of interest (1: high, 2: mean, 3: none, and 4: intended to take an interest in the near future) in his/her own individually selected preference classification. Accordingly, the preference classifications and the degrees of interest in the preference classifications may be used as the preference attributes to analyze and discern the preference date of the users.

The users of the client 11 who are joined and information of which are used as described above may input their own interest preference classifications, and also input individual degrees of interest in the individual interest preference classifications. Also, in the operating system 10 for displaying proximity preferences according to the present invention in which data inputs for individual users are collected, a total of the users using the terminals of the client 11 may be displayed in the form of a group, and a distance between the individual users may be determined according to the degrees of interest of the individual users when identical or similar interest preference classifications are divided into one group.

As described above, a user, who is a member which uses the terminal of the client 11 to gain access to, join and/or use the proximity preference processing system 20 which serves as a server in the operating system 10 for displaying proximity preferences, input the preference data including the degree of interest in the preference classifications and the individual interest preference classifications in which the user have been interested as described above. The preference data are transmitted from the terminal of the client 11 to the proximity preference processing system 20 to be processed.

As a result, the preference data received by the proximity preference processing system 20 may be stored in the member information storage unit 23, followed by carrying out a general member joining procedure or a log-in procedure.

For the interest preference data input by the individual member users during the member joining procedure, the preference analysis and classification unit 21 also receives and store the preference data of the users from the terminal of the client 11, and analyze and classify the preference data of the users by analyzing and classifying the preference data of the users based on the attributes for individual preference fields. In the case of an attribute for each field, a degree of interest according to the attribute may be determined as another attribute during the analysis and classification procedure of the preference data, and a magnitude in an interest magnitude attribute of each may be set as a size value, which may be divided by the magnitude attribute.

In addition, the proximity display set unit 22 may set an attribute of the preference data analyzed and classified by the preference analysis and classification unit 21, and a proximity distance between the users displayed at a short distance according to the magnitude size value. Therefore, the proximity display set unit 22 may form groups for users and fields, and also determine a degree of distance between the users displayed at a short distance according to the degrees of interest in the fields and groups.

The degree of distance between the users displayed at a short distance may be determined as a relative value which is a relative display distance to the fields of preferences to be analyzed and classified, or a relative display distance to the users having identical/similar preferences.

By way of example, when one user may set and input the highest degree of preference interest in an occupation, which is a degree of interest of 10, in the preference data including a preference classification and a degree of interest input by a corresponding user, a degree of preference interest in an education may be set as a degree of interest of 7 which is a value of the degree of interest lower than that of the occupation.

Also, a degree of interest in the preference classification for a hobby such as travel is set and input as a degree of interest of 8.5 which is a value between the degree of preference interest in an occupation and the degree of preference interest in an education. On the other hand, when a user is a married person and has a child, the user may be highly interested in upbringing of infants, and thus have a degree of interest of 9 in the preference classification of the upbringing of infants. On the contrary, a female user is highly interested in a family when one of family members serves in the army, but may have a degree of interest of 5 since the female user since the female user is interested in a family to a relatively low extent.

Also, when the degrees of interest in the interest preference classification and the individual preference classification are set as described above, and the preference data are input, analyzed and classified, the occupation, the education, the travel, the upbringing of infants and the like belong to the similar preference. Therefore, these preference fields may be arranged to be displayed at a shorter distance. In this case, the preference fields may be distributed together, and each may be set to be spaced apart by a value of the degree of interest.

However, since the preference fields are different from the above-listed interest preference classifications when the user serves in the army, the preference fields may be arranged to be displayed in an opposite direction and set to be disposed at a remote distance.

As described above, the preference data including the degrees of interest in the interest preference classification and the individual preference classification input by the user are received, analyzed, and classified. A mathematical operation may be performed on proximity display set data in a distribution chart which may be displayed according to the corresponding users and the preference attributes for the preference classification.

When the other users input added words, notices or announcements according to the corresponding classification in addition to the data on the preference classifications and the degrees of interest, such input items may be analyzed, and processed to be displayed as proper items corresponding to the input items.

In addition, in the case of the social meeting or selling of articles, an avatar, an icon, a character, a speech balloon and the like, all of which are differently viewed according to other many situations may be set to be displayed in a characteristic manner.

As described above, the preference data input by the user carrying the terminal of the client 11 are analyzed and classified according to the preference data attributes, and discerned to properly set the analyzed and classified results as attribute values for a size and extent of the input data. Then, the attribute values are stored in the preference field storage unit 24.

The data on the users analyzed, classifies and set as described above may also be transmitted to the individual terminal of the client 11 to be displayed on the individual GUI screen 12.

As a result, the GUI screen 12 of the client 11 receiving the set data of proximity display distance according to the preference classifications for the users may include a proximity preference display unit 30 configured to display users having similar preferences, and a function display unit 40 configured to allow a client user to input data or display a menu.

In this case, a number of users may use the proximity preference display unit 30 to display the data transmitted from the proximity preference processing system 20. For example, the users may be displayed on the proximity preference display unit 30 based on the groups including the similar preferences.

Then, each of the users displayed on the proximity preference display unit 30 may be displayed in the form of at least one selected from the group consisting of an avatar, a speech balloon, a text box, and a character.

Also, a logged-in user may be tinted with a color tone, and may be displayed in the form of at least one selected from the group consisting of an avatar, a speech balloon, a text box, and a character, and a user in a logged-out state may be displayed in the form of a frame as at least one selected from the group consisting of the avatar, the speech balloon, the text box and the character, or may be indicated in an achromatic color.

Of course, when a large number of users are displayed as a group, the interest preference classifications and the degrees of interest of the individual users received from the proximity preference processing system 20 are used as attributes, and set values are processed according to levels of the attributes. The resulting display data are transmitted to the client 11, so that the individual users can be displayed as a group on the proximity preference display unit 30 of the client 11, and that relative values of the degrees of interest for the individual users or groups can be expressed as a relative distance.

For the display items of the individual users displayed on the proximity preference display unit 30, the individual users may be displayed in the form of an avatar or a character to distinguish the individual users from each another, the items input by the users may be classified and displayed according to the features of the corresponding display attributes to correspond to the features of the data attributes displayed in a speech balloon, a notification, an announcements and the like.

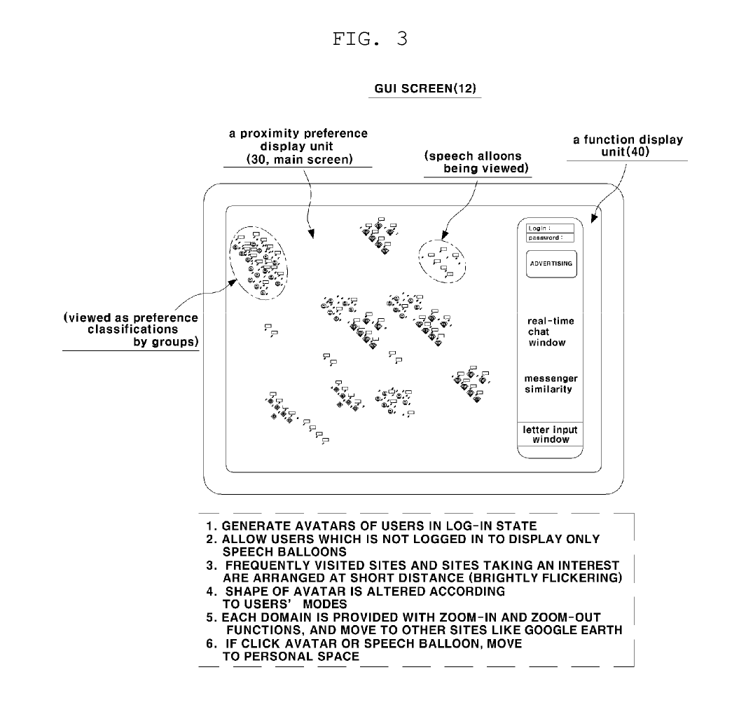

As shown in FIGS. 3 through 5, the contents which a user carrying the terminal of the client 11 want to input may be input to the function display unit 40 provided together with the proximity preference display unit 30, or a menu may be displayed on the function display unit 40 to select a desired menu. Also, the advertising contents may be displayed together using the proximity preference processing system 20.

In particular, referring to one case in which the individual users are displayed, as shown in FIG. 3, general users may be displayed as avatars with circular facial appearance. Also, the users may be displayed as avatars with diamond-type facial appearance in the case of the public institutions, or be displayed as business avatars with lozenge-shaped facial appearance. Also, when a text box or a speech balloon is required, the text box or the speech balloon may be provided to be displayed in plural numbers. A squared text box shown at a lower panel in FIGS. 3 through 6 is designed to further disclose the present invention. In fact, the text box may not be displayed on the GUI screen of the client 11, and thus the other users may convenient use the text box since the text box is executed to replenish and display helps or items to be particularly notified upon use of the operating system.

In addition, when a displayed zone of users displayed in the form of one of the avatar, the speech balloon, the text box and the character at the proximity preference display unit 30, which are displayed on the GUI screen 12 provided in the terminal of the client 11 so as to display the users in the form of the proximity preference attributes, is selected by the operating system 10 for displaying proximity preferences according to the present invention, a personal space screen 31 of the corresponding user may be displayed on the GUI screen 12.

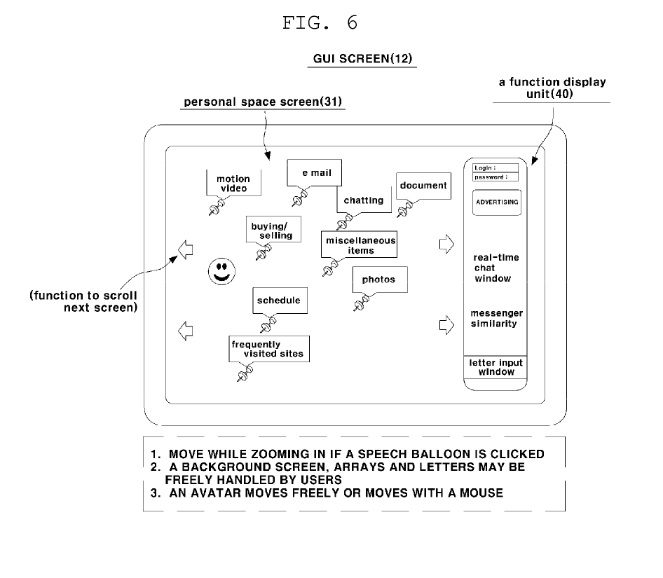

That is, the personal space screen 31 may be provided to clearly display the avatar, the character, the text box, the speech balloon and the like used by the user individual as shown in FIG. 6, and specifically display the contents according to the individual items. Also, the personal space screen 31 may be used to select the item to be amended, or may be provided to delete the unnecessary items or add new items.

The proximity preference processing system 20 configured thus may further include a personal space display unit 25 configured to search for data on display contents of a corresponding user to be displayed on the personal space screen 31 of the corresponding user and transmit the data on the display contents to the client 11 when the data obtained by selection of the displayed zone of users displayed on the GUI screen 12 of the terminal of the client 11 are received. Therefore, when an item attribute to be displayed on the personal space screen 31 is the individual user's own attribute, the user's own individual information, and information updated or used by the user may be displayed on the personal space screen 31. For example, such individual information may include motion videos, a mail box, a chatting service, a document board, a schedule, photos, other collection of miscellaneous items, engines for buying or selling articles, items provided in frequently visited sites, and the like. Also, when the item attribute to be displayed on the personal space screen 31 is another user's attribute rather than the user's own attribute, the publicly available contents updated by another user may include motion videos, documents, chat-related contents, publicly available parts in the miscellaneous items, photos, a board or added words. The entire contents are not displayed as a list in such a user-related display region, but may be displayed in the form of an avatar or a character according to each preference attribute, as shown in FIG. 6. Positions of the contents to be displayed and distances between the contents may be determined and displayed using an associative processing method.

In addition, the operating system 10 for displaying proximity preferences according to the present invention may be used to buy and sell articles. In this case, an avatar, a character and the like may be displayed to distinguish sellers wanting to sell articles from buyers wanting to buy the articles. Here, the operating system 10 for displaying proximity preferences according to the present invention may be provided to search for and check sale information and purchase information more easily by dividing and displaying the sellers and the buyers, and recording items which the sellers want to sell in a notice or a speech balloon.

An operating method of displaying proximity preferences in which the operating system 10 for displaying proximity preferences according to the present invention configured thus is used to display the users having the proximity preferences as a group will be described in further detail.

First, individual users input data using an interest preference classification field including various fields and kinds. To analyze and classify the attributes for such an interest preference field and also determine and calculate an extent of distance, at which the users are arranged when they are displayed, according to a value of the interest magnitude attribute, an analysis/classification engine or a calculation engine capable of storing reference data analyzed and classified for the data attributes in the proximity preference processing system 20 and analyzing and classifying the reference data according to the data attributes may be provided.

Also, a configuration of a server operating system capable of generally carrying out a process to join individual users as members or generally executing a log-in procedure of pre-joined members may be provided.

Therefore, a user inputs the data on member information and joining information before use to carry out a member joining procedure of the individual user or a log-in procedure of the joined member.

During such a joining procedure, or in a logged-in state after the joining, a client used by the user may be executed to receive preference data including the degrees of interest in the interest preference classification and the corresponding preference classification and transmit the preference data to the proximity preference processing system 20.

As described above, after a procedure of inputting data of users and a procedure of receiving member information data and preference data are carried out, a preference analysis and classification step (S01) of processing preference data of a user input from the client 11 may be carried out. Here, the preference data of the user may be analyzed based on the attributes, and classified based on the individual preference attributes.

As described above, a step of classifying an attribute of the interest preference for the individual user data and analyzing a degree of interest according to each preference attribute may be carried out.

Also, a proximity displaying and setting step (S02) of setting a proximity distance at which users are displayed at a short distance according to the preference data classified in the preference analysis and classification step (S01) is carried out.

That is, a procedure of setting a proximity distance is carried out to allow individual users to form groups including users having similar common preferences and hobbies based on the preference classifications and also setting a display distance between the individual users or a display distance between the groups as a relative value.

As described above, after the set data of proximity distance according to the preferences of users, and the user display data used to display users in the form of any one selected from the group consisting of an avatar, a speech balloon, a text box and a character, which correspond respectively to the users undergoes a procedure of classifying and analyzing the preferences according to the data attributes of the individual users and performing a mathematical operation on the proximity distance, the set data of proximity distance and the user display data are transmitted from the proximity preference processing system 20 to the client 11 to be displayed on the proximity preference display unit 30 provided in the GUI screen 12 of the client 11. In this way, a user-in-preference-group displaying step (S03) of displaying a large number of users in preference groups may be carried out.

That is, as shown in FIG. 3, the individual users may be displayed as various groups including user having similar preferences, hobbies or merits, and including buyers, sellers, or buyers and sellers for buying and selling articles, for example, may be displayed in the form of an avatar, a character and the like. Also, a speech balloon, a text box, a picture box and the like may be displayed together.

Therefore, the individual users may easily locate and check groups of the same preferences as the individual users themselves.

The preference data of the users which may be executed in this way may include preference attributes and data attributes of interest in various preference fields such as an occupation preference, a region preference, a hobby preference, a sports preference, a merit preference, an interest preference, a schoolmate preference, a hometown preference, a social club preference.

In addition, in the operating method of displaying proximity preferences according to the present invention, an individual selection/information transmission step (S04) of transmitting the individual selection data, in which a displayed zone of user individuals selected from the group consisting of an avatar, a speech balloon, a text box and a character in the proximity preference display unit 30 displayed on the GUI screen 12 provided in the terminal of the client 11, from the client 11 to the proximity preference processing system 20 may be further carried out.

Also, an individual information displaying step (S05) of searching for information on the corresponding individual users, transmitting searched data on individual information data from the proximity preference processing system 20 to the client 11 and displaying the individual information data on the personal space display unit 25 of the GUI screen 12 of the client 11 may be further carried out at the proximity preference processing system 20 configured to receive the individual selection data.

According to the operating system 10 for displaying proximity preferences according to the present invention as configured thus, and the operating method of displaying proximity preferences using the operating system 10 for displaying proximity preferences, a visualized map other than a conventional standardized and documented communication system is used to display data on the GUI screen 12 provided in the terminal of the client 11. Accordingly, the visualized map is used as a new communication tool which is provided with new-age thinking and is convenient.

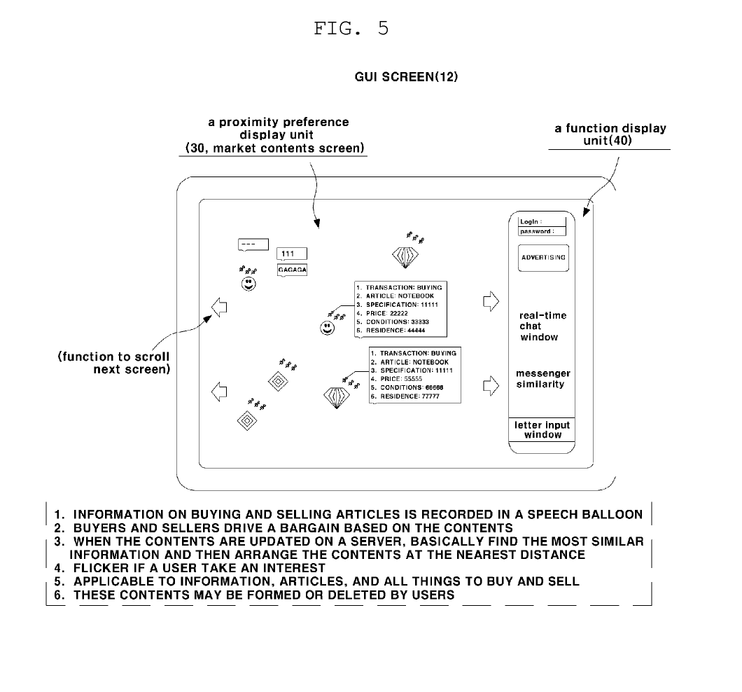

Also, a specialized group such as sellers and buyers dealing with the market contents as shown in FIG. 5 may be formed based on the interest preference classifications and fields of the individual users to operate a selling site. Also, a user group may be formed according to similar fields, interests or intimacy, or the other interests, preferences or features to execute a chatting site, an exclusive short message transmission site, a twitter, and other websites. Further, a user may easily check the respective individual groups and individual users with the naked eye by setting and sharing the distances displayed between the individual users or between the groups.

In addition, the terminal of the client 11 on which the users belonging to such interest preference classifications or the groups including the users are displayed is applicable to various terminals such as a typical desktop computer, a notebook computer, a portable terminal, a portable mobile communication terminal, a navigation system and an interactive television.

Additionally, an inference engine (Semantic web) provided to analyze and classify information input by the users may be provided to search for, analyze and classify persons (other users) having the same verified preference, taste and category simply and rapidly in a real-time manner.

From the analysis and classification results, the users having the similar preferences and hobbies may be displayed to be arranged adjacent to each other. Also, the users having the similar preferences are tinted with a thick color tone, or displayed like twinkling stars to easily distinguish the users having the similar preferences.

Also, the users having the similar preferences and hobbies used a search tool provided in a site to automatically search for and enter a group. In this case, the users may transcribe and visualize cafes, blog lists, etc.

Then, visit histories, search letters, matters of interest, hobbies and activities (games, etc.) of the users are classified in a type classification system using Semantic web which has come into the spotlight as a search tool with Web 2.0 or Web 3.0 version so that the users having the similar interest preferences and hobbies can be displayed adjacent to each other.

In addition, a main screen (skin) may be designed in the form of the globe to display each group like the Five Oceans and Six Continents, and display each group like an island which spreads on an enormous plane. As a result, a more dynamic main screen on which the items are displayed in the form of the group and the globe rather than the general text may be constructed.

Also, the users may be classified into major groups, and displayed on the main screen. In this case, when a certain major group is selected from the major groups on the main screen, a sub-group individual screen configured to display detailed sub-groups of the selected major group may be processed to spread. Such individual sub-groups may be run to be further divided into sub-sub-groups including a large number of steps.

Also, when an individual user is selected on the sub-group individual screen, a personal space screen of the individual user may be displayed, and a seller selling articles handle the sub-group individual screen to display the specific kinds of articles soled by a seller.

Furthermore, a sentence or a drawing is displayed in a speech balloon, a text box or a picture box, which is in the form of an anchor for organizations or individuals forming each group, to allow an individual user to search for users having similar hobbies and preferences more easily, thereby facilitating communications.

Accordingly, the operating system for displaying proximity preferences according to the present invention may provide an avatar or a character, which may form a user's own image as displaying individual users displayed on the GUI screen of the individual client terminal in the form of an avatar, thereby facilitating distinguishing between the individual users.

Also, such an avatar or a character may be used to express his/her own mood and current thought, and may be displayed with proper shapes by analyzing the mood and current thought of the user according to the data selected or input upon the log-in. Also, a logged-in state or a logged-out state may be used to check the access state of the avatar and the character, and the user may use a mouse or a cursor to adjust a display position of his/her own avatar.

In addition, it is assumed that a user runs a selling site. In this case, since the user generally searches for the contents of interest through letter search in a search engine, the fact of which may be currently realized in social network service (SnS), it is difficult to find the contents. However, the contents of interest may be linked to fields of interest, and also may be easily checked and found by describing the desired conditions in a speech balloon and the like.

For operation of the system, the search engine may be used as a means for cost payment by providing points according to access frequency and an access time zone, and may be provided to enable internet or mobile access.

When a user uses the system according to the present invention operated thus, a total of members will be first displayed on the main screen. Then, only the members in a logged-in state are checked to display an avatar, but the members who are not in a logged-in state may be displayed in the form of a speech balloon.

Further, when a user clicks his/her avatar in a menu, the user may see users around his/her avatar as his/her avatar is zoomed in. As a result, the user may see the other users arranged around his/her avatar, for example, persons in which the user is interested, and persons having the most similar preferences to the user arranged adjacent to the user.

Also, the user may change the avatar according to the user's mood after the log-in, and may be set to flicker ions of frequently visited sites or things of interest or change colors of the frequently visited sites or things of interest. In this case, a scroll function may be provided to move easily to the next screen, and the frequently visited sites may be enrolled in a function display unit set aside on a screen to move easily to a selected site when the selected site is clicked.

Furthermore, when a personal avatar or a speech balloon is clicked, a current screen moves to a personal space. In this case, as all the spaces are opened to the users, a user may form and delete his/her own space. A user may form a space in which users may chat with an on-line system, invite and chat with other users. Since the space for invitation of and chatting with the other users may be provided like a coffee shop, a movie room, a theater and the like, the user may enjoy the corresponding theme with the users who are invited according to the corresponding theme. In the case of a movie, the user may enjoy arguing about selling movie tickets in advance, or synchronizing moving images, or listening to music together. Also, when a park is determined as a theme, the users may download a motion video or pictures of a park which users want to go and see in a background screen, and may use the operating system as a place for meeting so as to talk about the part and trade the business perspective.

For the operating system 10 for displaying proximity preferences and the operating method of displaying proximity preferences according to the present invention provided as described above, the applicable fields may include various fields, for examples, a social network service, such as twitters and facebooks, which comes into the spotlight in recent years, and internet services such as chatting services, blogs, NateOn and Cyworld, as well as the social media such as general clubs, portal services and the internet. In this case, the operating system and operating method for displaying proximity preferences may be run in the field of various applications.

Accordingly, the data according to the fields are input according to the way used by a large number of users, and the data input during member joining or internet use may be stored, analyzed and classified based on the user attributes. As a result, the procedure of analyzing and classifying the data may be carried out in the preference analysis and classification unit 21 of the proximity preference processing system 20 according to the present invention. For this purpose, the preference analysis and classification unit 21 may be specifically configured to include outfits for reading the stored data of users, and processing engines for analyzing the preference data input by the users according to the attributes and classifying the preference data according to the corresponding attributes.

As a result, the attributes of the information data on member joining or the information data on bulletins or supplementary information memos may be generally analyzed in advance.

Referring to analysis of most of the input data, a user inputs data in the form of English or Hangeul, or in various forms about which other users may easily recognize. The form of such letters may be divided based on the words to determine the attributes of the letters based on the divided words. In this case, a method of processing a natural language may be applied to carry out analysis of the attributes of the preference data.

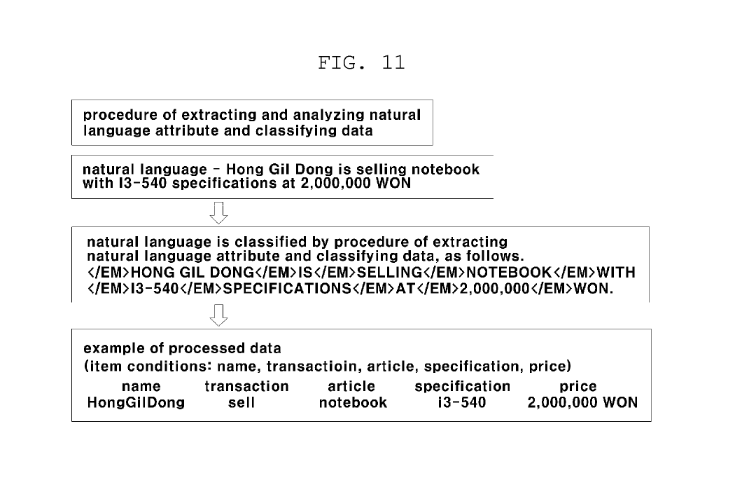

That is, for the sentences generally input as shown in FIG. 11, the attributes may be detected for the entire sentences including words, letters and spaces between the letters.

The preference analysis and classification procedure may be carried out by properly analyzing and classifying the detected attributes, based on a predetermined attribute table.

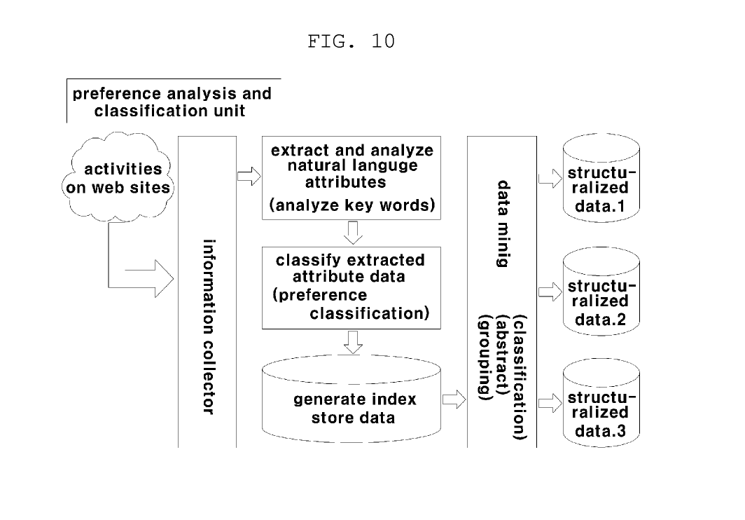

For the preference data input as shown in FIG. 10, the attribute features may be classified during analysis of the entire sentence using a method of processing a natural language, and the classified attributes may be classified and stored into structuralized data types which have been divided already.

That is, referring to one example of a sentence shown in FIG. 11, for the natural language sentence ‘Hong Gil dong’ is ‘selling’ a ‘notebook’ with ‘i3-540 zspecifications’ at ‘2,000,000 Won,’ a natural language analysis engine according to the present invention may be used to analyze the natural language sentence, based on the data on attribute classification words such as, ‘Hong Gil dong,’ ‘i3-540specification,’ ‘notebook,’ ‘2,000,000 Won,’ and ‘sell’ by performing a procedure of analyzing the attributes except the spacing words and search parts in the natural language sentence.

Also, the attributes divided thus may be classified through inquiry into the typically stored attribute classification table: that is, the term ‘Hong Gil dong’ is stored as a person attribute, the term ‘i3-540specification’ is stored as an article attribute, the term ‘notebook’ is stored as an article classification attribute, the term ‘2,000,000 Won’ is stored as a price attribute, and the term ‘sell’ is stored as an action attribute. A kind of a data mining procedure of analyzing and classifying the preference data of the users, which are input in the form of a natural language, based on the attributes is performed as described above. Then, the classified corresponding attributes may be connected with the users' accession numbers associated with the respective attributes to be store in the structuralized data classifications.

In the case of the data on preference attributes of the users analyzed and classified as described above, a procedure of reading the data on preference attributes of the users and analyzing the read data as a value of the data which may be displayed according to a degree of proximity may be performed at the proximity display set unit 22.

Referring again to one example of the sentence shown in FIG. 11, articles being sold with a transaction attribute may be displayed as one bundle, the term ‘Hong Gil dong’ may be displayed with an attribute resembling the name attribute, or the ‘notebook’ attribute may be classified into the article attribute, or proximally classified into specification or price attribute.

That is, referring again to one example of the sentence shown in FIG. 11, when users selling a notebook are able to form a group, a seller group having similar specification and price attributes may be formed to be displayed together.

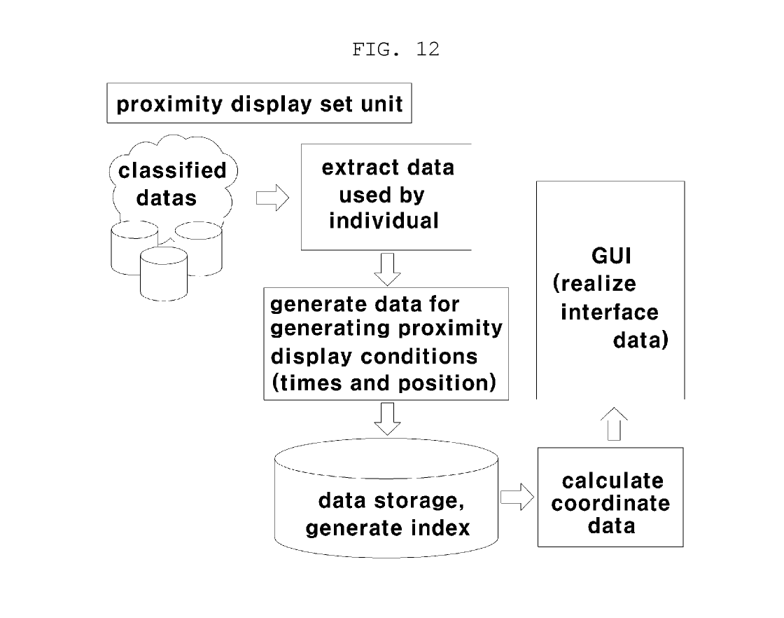

According to one exemplary embodiment regarding the attribute classification, as shown in FIG. 12, the data input by the users to undergo the analysis and classification procedure may be subjected to a procedure of classifying and analyzing the data on individual users, which can set a basic group capable of extracting and displaying the data on individual users, set the data on basic individual users such as regions, clubs, chats, article sales, and the like, or set the type of a character or an avatar for displaying the corresponding user.

Also, the data on the corresponding users may be used to analyze the preference attributes and extract the users which may be displayed as groups.

After extraction of the users which may be displayed as groups, a distance at which each user is displayed may be calculated with respect to the corresponding attributes.

Accordingly, when a notebook is the criterion for users, similar devices such as a desktop computer, Galaxy Tab, iPad and the like may be set as a similar group to classify the users carrying the similar devices.

In addition, the notebook computers may be grouped according to the kinds of computers and the manufacturing companies.

In particular, articles of the same manufacturing company may have set values so that a relative display distance can be set to be short when the article specifications are similar, but the articles having definitely different specifications can be displayed at a relatively remote distance.

Also, when the articles have similar specifications but there is a significant difference in notice date of the articles and/or distance between the articles, the articles may be displayed within a short distance by determining the difference in notice date and distance as a relative display value even when the articles have been relatively currently posted and the user are displayed at a short distance.

Thereafter, when a mathematical operation is performed on the proximity display distance, the data are stored, and a coordinate value is calculated based on the stored data.

That is, as described above, the coordinate value may be calculated according to a set value of the calculated data on the similar group and the proximity distance. For example, one axis may be calculated as a time axis, and the other axis may be calculated as a position/distance axis. Also, one axis may be set as a seller, buyer or producer axis, and the other axis may be set as an article or price axis.

After the values of the coordinate data calculated thus are stored, the values of the coordinate data may be transmitted from the proximity preference processing system 20 to the client 11 and displayed on the GUI screen 12 of the client 11.

The input data of the large number of users originally input in the form of a natural language, including the criteria for calculation of the calculated coordinate data, and the field attributes and taste attributes of the preferences to be displayed, may be processed based on the attribute table in which the input data of the users are analyzed and classified based on the attributes, or an analysis/classification standard table in which attribute classification levels are input in advance as predetermined values by a system operator. In addition, the input data of the users may be executed to be optimally displayed based on the individual taste by inputting or adjusting the classification/analysis standards and the preference kinds which the individual users themselves want to see or find.

Therefore, since the individual users may easily see other users who the individual users want to see by grouping the other users as well as their own taste or liking, various exchanges may be easily carried out in various fields. In particular, active network activities may be achieved since the individual users may check and utilize desired menus or the status of respective users at a glance, as shown in FIGS. 3 through 6.

As described above, the operating system for displaying proximity preferences according to the present invention can be useful in establishing an information communication Environment so that users having similar preferences or interests can form a group to be displayed and checked on a terminal screen within a short distance, thereby easily checking the status of users or institutions having similar interests and preferences, and allowing the users or institutions to do positive activities so as to obtain new information quickly and easily as well.

Also, the operating system for displaying proximity preferences according to the present invention can be useful in allowing users to easily view similar preferences or matters of interest, or notices associated with the users forming a group by means of one of a speech balloon, a text box and the like, thereby facilitating new information exchange between the users.

What is claimed is:

1. An operating system for displaying proximity preferences, comprising:
a proximity preference processing system configured to receive data from a client and transmit set data of a proximity display distance according to preference classification for users toward the client by preference classification for data of a client user,
wherein the proximity preference processing system comprises:
a preference analysis and classification unit configured to receive preference data of users of the client, analyze the preference data and classify the preference data of the users according to individual preference data;
a proximity display set unit configured to set a proximity distance in which the users are displayed adjacent to each other according to the data classified by the preference analysis and classification unit;
a member information storage unit configured to store data of user members;
and a preference field storage unit configured to store the set data of the proximity display distance set according to the data of the preference classification for the users and attributes of preference data.

2. The operating system of claim 1, wherein a GUI screen of the client to receive the set data of proximity display distance according to the preference classification for the users comprises:
a proximity preference display unit configured to display the users according to similar preference attributes;
and a function display unit configured to allow the client user to input data and display a menu,
wherein the proximity preference display unit is configured to display the users based on groups including the similar preference attributes, and express the respective users as at least one selected from the group consisting of an avatar, a speech balloon, a text box and a character, and
the users are displayed on the proximity preference display unit so that a logged-in user is tinted with a color tone, or is displayed as at least one selected from the group consisting of the avatar, the speech balloon, the text box and the character, all of which are colored, and a user in a logged-out state is displayed in the form of a frame as at least one selected from the group consisting of the avatar, the speech balloon, the text box and the character, or is indicated in an achromatic color.

3. The operating system of claim 2, wherein the personal space screen of the corresponding user is displayed when a displayed zone of the users is selected in the form of one of the avatar, the speech balloon, the text box and the character in the proximity preference display unit displayed on the GUI screen of the terminal of the client, and
the proximity preference processing system further comprises a personal space display unit to search for data of display contents regarding the corresponding user displayed on the personal space screen of the corresponding user and transmit the data toward the client when the data are received according to selection of the displayed zone of the user displayed on the GUI screen of the terminal of the client.

4. An operating system for displaying proximity preferences, comprising:
a proximity preference processing system configured to receive data from the client and transmit set data of a proximity display distance according to preference classification for the users toward the client by preference classification for data of the client user,
wherein the terminal of the client is configured to receive the set data of the proximity display distance according to the preference classification for the users, and a GUI screen of the client comprises:
a proximity preference display unit to display users based on similar preference attributes; and
a function display unit to allow a client user to input the data and display a menu,
wherein the proximity preference display unit is configured to display the users based on groups including the similar preference attributes and express the respective users in the form of a group including at least one selected from the group consisting of an avatar, a speech balloon, a text box and a character according to the similar preference attributes.

5. An operating method of displaying proximity preferences, comprising:
a preference analysis and classification step of receiving preference data of users from a client, analyzing the preference data and classifying the preference data of the users based on individual preference attributes;
a proximity displaying and setting step of setting a proximity distance in which the users are displayed adjacent to each other according to the preference data classified in the preference analysis and classification step;
and a user-in-preference-group displaying step of transmitting set data of proximity distance according to the preference attributes of the users and user display data for displaying users as a group including at least one selected from the group consisting of an avatar, a speech balloon, a text box and a character corresponding to each of the users from a proximity preference processing system to the client and displaying the set data of proximity distance and the user display data on a proximity preference display unit of a GUI screen of the client, wherein the users are displayed for a preference group including a large number of users.

6. The operating method of claim 5, further comprising:
an individual selection/information transmission step of transmitting individual selection data, in which a displayed zone of user individuals is selected in the form of one of the avatar, the speech balloon, the text box and the character in the proximity preference display unit displayed on the GUI screen of the terminal of the client, from the client to the proximity preference processing system; and
an individual information displaying step of receiving the individual selection data, searching for information on corresponding individual users, transmitting searched data on individual information data from the proximity preference processing system to the client and displaying the individual information data on a personal space display unit of the GUI screen of the client.

7. The operating method of claim 5, wherein the preference data of the users comprises data including at least one selected from the group consisting of an occupation preference, a region preference, a hobby preference, a sports preference, a merit preference, an interest preference, a schoolmate preference, a hometown preference, and a social club preference.
